(19) United States
(12) Patent Application Publication
(10) Pub. No.: US 2012/0032451 A1
(43) Pub. Date: Feb. 9, 2012

(54) SEWER ENERGY MILL SYSTEM

(76) Inventors: Erric Heitmann, Liverpool, NY (US); James Lounsbery, Middletown, NY (US); Carlos Tabares, Paterson, NJ (US)

(21) Appl. No.: 12/851,201

(22) Filed: Aug. 5, 2010

(51) Int. Cl. H02P 9/04; H02K 7/116; H02K 7/18

(52) U.S. Cl. 290/1 D; 290/52; 290/43

(57) ABSTRACT

A sewer energy mill system is provided for converting kinetic energy possessed by the wastewater flowing through a sewer line into electrical energy. The system may be installed within a conventional existing manhole infrastructure of the sewer system or within a customized structure specifically designed to accommodate the system and installed into the sewer system

### FIELD OF THE INVENTION

This invention relates generally to the hydropower generation of electricity in sewer lines and, more particularly, to a system capable of being installed in a sewer system for converting the kinetic energy of the fluid flowing through a sewer line into electrical energy.

### BACKGROUND OF THE INVENTION

In developed countries worldwide, most cities, villages and other areas of human population concentration have installed sewer systems to handle sanitary waste from homes, apartment buildings, office buildings, industrial complexes and other concentrations of human activity. The sanitary waste is diluted with water at its source and delivered through branch lines into a sewer system formed of a network of sewer lines. The sewer system generally includes a plurality of trunk lines that receive the wastewater from the branch lines and deliver that wastewater to a sewer main line that typically discharges into a sewage treatment plant.

The sewer systems are designed such that the pre-treatment wastewater will flow from the multiplicity of sources through the branch lines, trunk lines and main lines to the sewage treatment plant. Generally, this is accomplished by providing a downhill declination to each of these lines in the direction of flow through the lines whereby the flow passes through the sewer system under the force of gravity. At selected locations in the sewer lines, pump stations may be provided to pump the wastewater from a lower elevation to a higher elevation from which the pre-treatment wastewater will continue to flow downhill under the force of gravity. Therefore, the wastewater flowing through the various sewer lines of the sewer system possesses kinetic energy.

### SUMMARY OF THE INVENTION

A system is provided for converting kinetic energy possessed by the wastewater flowing through a sewer line into electrical energy. The system may be installed within a conventional existing manhole infrastructure of the sewer system or within a customized structure specifically designed to accommodate the system and installed into the sewer system.

The sewer energy mill system includes an energy extracting device mounted to a rotatable shaft, an alternator for generating electricity having a rotatable shaft, a gearing mechanism connecting the shaft of the energy extracting device to the shaft of the alternator for rotating the shaft of the alternator, and an inlet channel configured to be installed within the sewer line upstream with respect to wastewater flow of the energy extracting device, the inlet channel having a throat defining a variable flow area. The energy extracting device is positioned whereby wastewater flowing through the sewer line impacts the energy extracting device thereby rotating the shaft of the energy extracting device. The system may also include an inflatable bladder disposed in the sewer line upstream with respect to wastewater flow of the energy extracting device.

In an embodiment, the energy extracting device comprises a paddlewheel drum having a plurality of outwardly extending paddles. In an embodiment, the energy extracting device comprises a turbine having a plurality of blades

The system may also include a controller operative to selectively vary the variable flow area of the throat of the inlet channel. The controller may also be operative to selectively inflate the inflatable bladder. At least one flow velocity sensor may be associated with the controller for sensing a flow velocity of the wastewater approaching the paddlewheel drum and transmitting a signal indicative of the sensed flow velocity to the controller. At least one flow depth sensor may be associated with the controller for sensing a depth of the flow of the wastewater approaching the paddlewheel drum and transmitting a signal indicative of the sensed flow depth to the controller. At least one pressure sensor may be associated with the controller for sensing the head pressure of the flow and transmitting a signal indicative of the sensed head pressure to the controller.

In an embodiment, the controller compares the sensed flow velocity to a design threshold velocity, selectively decreases the flow area of the throat of the inlet channel if the sensed flow velocity is less than the design threshold velocity, and selectively increases the flow area of the throat of the inlet channel if the sensed flow velocity exceeds the design threshold velocity. In an embodiment, the controller compares the sensed flow depth to a design threshold depth and selectively inflates the bladder if the sensed flow depth exceeds the design threshold depth. In an embodiment, the controller adjusts the flow area of the throat of the inlet channel inversely to the sensed head pressure.

### BRIEF DESCRIPTION OF THE DRAWINGS

For a further understanding of the disclosure, reference will be made to the following detailed description which is to be read in connection with the accompanying drawing, where:

FIG. 1 is an elevation view, partly in section, of the sewer energy mill disclosed herein positioned within a manhole of a sewer system;

FIG. 2 is an elevation view, partly in section, of the sewer energy mill of FIG. 1 substantially as viewed from line 2-2 of FIG. 1; and

FIG. 3 is a schematic diagram illustrating an exemplary embodiment of the control system of the sewer energy mill disclosed herein.

### DETAILED DESCRIPTION OF THE INVENTION

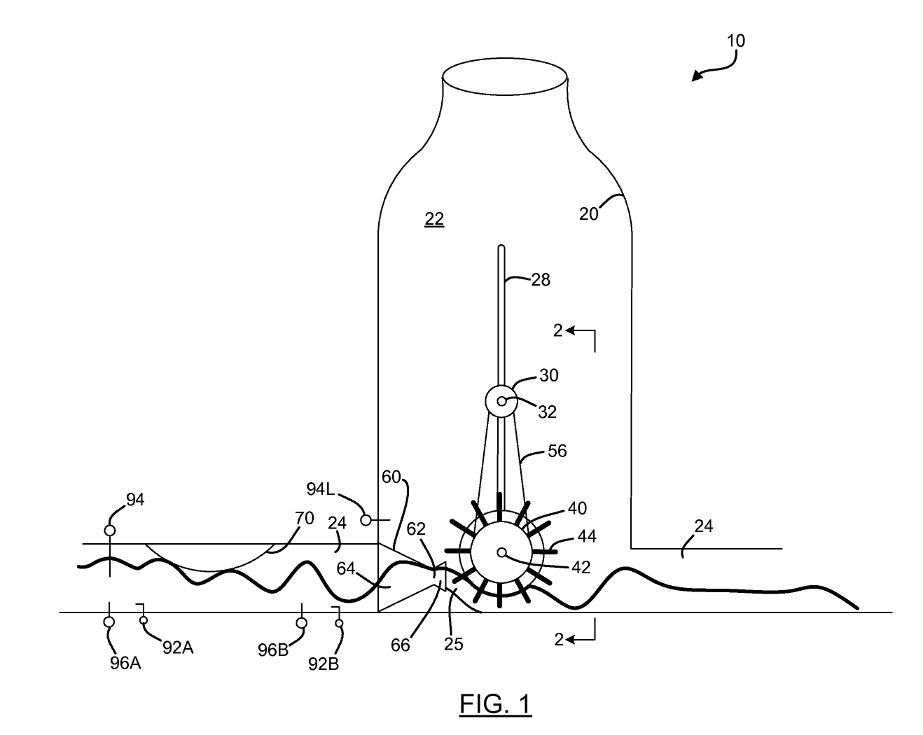

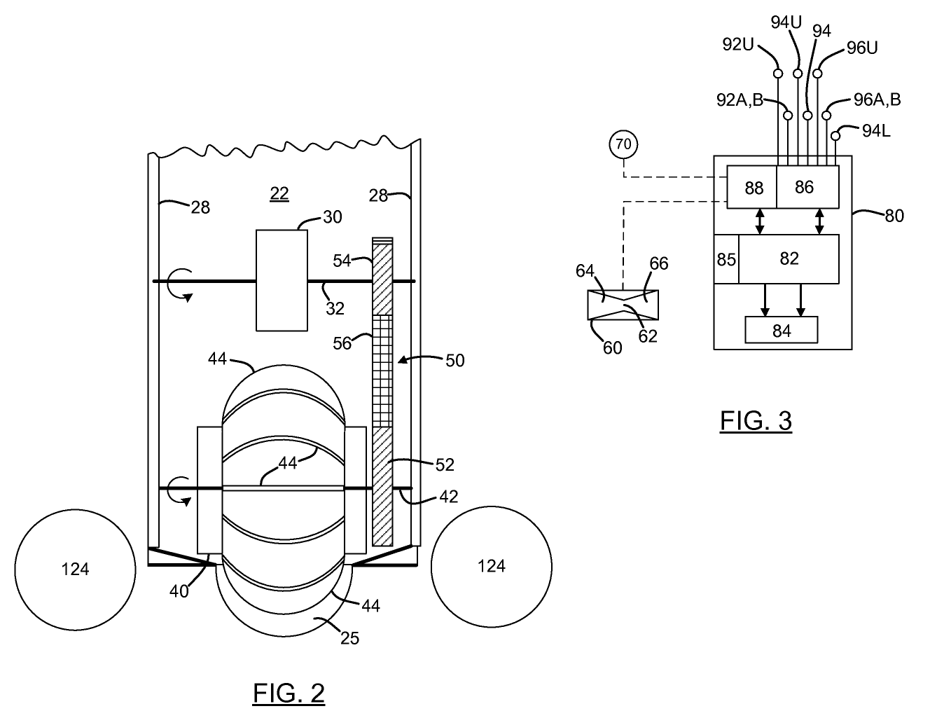

Referring initially to FIGS. 1 and 2, there is depicted an exemplary embodiment of a sewer energy mill system, designated generally as 10, disposed in chamber 22 of a conventional manhole structure 20 opening into a sewer line 24 of a conventional sewer system. The sewer energy mill system 10 constitutes a system for converting the kinetic energy of wastewater flowing through the sewer line 24 into electrical energy. The term wastewater as used herein is to be understood to include sanitary wastewater per se, as well as mixed sewer line wastewater flows, for example mixed sanitary wastewater and storm system drainage flows. The generated electricity may be supplied to an electric power grid for distribution or may be supplied to a dedicated facility or for a dedicated use or to a battery, a capacitor or other storage device for subsequent delivery to an electric power grid or to a dedicated device or use.

The sewer energy mill system 10 includes an energy extracting device 40 and an alternator 30 for generating electricity and operatively connected to the energy extracting device. The sewer energy mill system 10 will be further discussed and described herein with reference to the depicted embodiment of the sewer energy mill system 10, wherein the energy extracting device 40 comprises a paddlewheel drum. However, it is to be understood that in other embodiments, the energy extracting device 40 could comprise a water turbine having a plurality of paddles mounted to a rotatable shaft or other device for extracting energy from the momentum of flowing water for rotating a shaft to which the device is mounted.

The paddlewheel drum 40 is mounted to a rotatable shaft 42 that is disposed along a central axis of the paddlewheel drum 40. The shaft 42 extends across the manhole chamber 22 and the respective ends of the shaft 42 are supported in rails 28 extending generally vertically on diametrically opposite sides of the wall of the manhole structure 20. The paddlewheel drum 40 also includes a plurality of paddles 44 extending radially outward from the paddlewheel drum 40. The paddles 44 are distributed about the circumference of the paddlewheel drum 40 at equally spaced intervals. The shaft 42 of the paddlewheel drum 40 is positioned within the manhole structure 20 such that paddles 44 on a lower portion of the paddlewheel drum 40 extend into the channel 25 of the sewer line 24 at the bottom of the manhole chamber 22. Each paddle 44 has a generally semi-circular shape, the number and size of the paddles 44 being selected for maximum wastewater flow impact to the paddlewheel drum 40 to allow for maximum transfer of kinetic energy into rotational energy to the paddlewheel drum 40.

The alternator 30 has a rotatable shaft 32 that extends across the manhole chamber 22 with the respective ends of the shaft 32 being supported for rotation from the wall of the manhole structure 20. The shaft 32 of the alternator 30 is operatively connected to the paddlewheel drum 40 so as to be driven in rotation as the paddlewheel drum 40 rotates. Rotation of the shaft 32 results in electric current being output by the alternator 30.

A drive mechanism 50 is provided for operatively connecting the shaft 32 of the alternator 30 to the shaft 42 of the paddlewheel drum 40. For example, as depicted in the drawing, the drive mechanism 50 may comprise a gearing mechanism that includes a drive gear 52 mounted on the shaft 42 of the paddlewheel drum 40, a driven gear 54 mounted on the shaft 32 of the alternator 30, and a drive belt or chain 56 to transmit rotational force from the drive gear 52 to the driven gear 54. The drive gear 52 has a diameter that is several times greater than the diameter of the driven gear 54, whereby the shaft 32 of the alternator 30 will be driven at a greater rotational speed than the rotational speed at which the shaft 42 of the paddlewheel drum 40 rotates. It is to be understood, however, that the drive mechanism 50, rather than having a belt or chain drive, could constitute a series of intermeshing gears linking the drive gear 52 on the shaft 42 to the driven gear 54 on the shaft 32 of the alternator 30. It is also to be understood that the shaft 32 of the alternator 30 could be operatively connected to the shaft 42 of the paddlewheel drum 40 by a direct drive arrangement, rather than through a gearing mechanism.

In operation, as the sewer wastewater passing through the sewer line 24 traverses the channel 25 at the bottom of the manhole chamber 22, the force of the sewer wastewater flowing through the channel 25 against the paddles 44 causes the paddlewheel drum 40 to rotate together with the paddlewheel shaft 42 and the drive gear 52 mounted thereto. The rotation of the drive gear 52 is transmitted to the driven gear 54 by the belt or chain 56 thereby causing the shaft 32 of the alternator 30 to rotate. The rotation of the shaft 32 results in the generation of electric current in the alternator 30. In this manner, a portion of the kinetic energy of the sewer wastewater is recovered and effectively converted to electrical energy. The generated electric current may be delivered through a cable (not shown) to an electric power grid for distribution or may be supplied to a dedicated facility or for a dedicated use or to a battery, a capacitor or other storage device.

The sewer energy mill system 10 may also include an inlet channel 60 having variable flow area throat 62 installed within the sewer line 24 upstream with respect to wastewater flow of the paddlewheel drum 40. The inlet channel 60 receives the wastewater flow flowing from the sewer line 24 into channel 25 and redirects the received wastewater flow toward the paddlewheel drum 40 to more effectively impact the paddles 44. If a different energy extracting device were employed, for example a water turbine, the inlet channel 60 would be arranged to most effectively direct the wastewater flow into that energy extracting device. The inlet channel 60 defines a convergent passage 64 extending from the inlet end of the inlet channel 60 to throat 62. The inlet channel 60 may also define a divergent passage 66 extending downstream from the throat 62 to the outlet end of the inlet channel 60. In an embodiment, the inlet channel 60 may comprise a venturi having a variable throat area.

Additionally, the sewer energy mill 10 may include a selectively inflatable bladder 70 disposed within the sewer line 24 upstream with respect to the inlet channel 60. The bladder 70 may be mounted to the crown (i.e. roof) of the sewer line 24, for example as depicted in FIG. 1, and maintained in a deflated state during normal levels of wastewater flow. During conditions when the level of the wastewater flow becomes higher than a design threshold depth for operation of the energy mill system 10, the bladder 70 may be inflated to partially block the flow passage defined by the sewer line 24, thereby controlling the level of the wastewater flow received at the inlet channel 60. The bladder 70 may, for example, be made of rubber or other elastomeric material.

Referring now to FIG. 3, there is depicted schematically an exemplary embodiment of a control system 80 operatively associated with the sewer energy mill system 10. The control system 80 includes a controller 82 and a plurality of sensors, including at least one flow velocity sensor 92 and at least one flow depth sensor 94. A pressure sensor 96 may also be included. The controller 80 comprises a microprocessor 82 and its associated memory 84, an input/output interface 85, including an analog-to-digital converter 86, and drive circuits 88 for receiving commands from the microprocessor 82 and in turn controlling various components of the sewer energy mill system 10. The flow velocity sensor 92 measures and transmits a signal indicative of the flow velocity of the wastewater entering or within the flow channel 25. The pressure sensor 96 measures and transmits a signal indicative of the water pressure. The flow velocity sensor 92 and the pressure sensor 96 may be positioned in the sewer line 24 upstream of the bladder 70 (so positioned designated as 92A, 96A in FIG. 1) or at or near the entrance to the flow channel 25 (so positioned designated as 92B, 96B in FIG. 1) or within the flow channel 25, but upstream of the point at which the wastewater impacts the paddlewheels 44. The flow depth sensor 94 measures and transmits a signal indicative of the depth of the wastewater flowing through the flow channel 25. The flow depth sensor 94 may be positioned within the sewer line 24 upstream of the flow channel 25 and generally upstream of the bladder 70 as illustrated in FIG. 1.

The controller 80 receives the signal indicative of wastewater flow velocity from the flow velocity sensor 92 and the signal indicative of the depth of the wastewater from the flow depth sensor 94 through the input/output interface 85 wherein any received analog signals are converted by the analog-to-digital converter 86 to digital signals. The controller 80 processes the received signals and determines what action, if any, is necessary to maximize electricity generation. For example, if the sensed wastewater flow velocity is slower than necessary to maximize electricity generation, the controller 80 will further close the throat 62 of the inlet channel 60 thereby reducing the flow area through the throat 62 of the inlet channel 60 to increase the wastewater flow velocity and accelerate the flow of wastewater into the paddles 44 to increase the rotational speed of the paddlewheel drum 40. Conversely, if the sensed flow velocity exceeds a design threshold velocity, which if exceeded could cause the paddlewheel drum 40 to stall or cease rotation, the controller 80 will further open the throat 62 of the inlet channel 60 to increase the flow area through the inlet channel 60 to decrease the wastewater flow velocity through the channel 25.

Additionally, if the sensed flow depth of the wastewater through the channel 25 is outside a design depth range, the controller 80 may adjust the inflation of the inflatable bladder 70. If the sensed flow depth of the wastewater through the channel 25 is above an upper threshold depth of the design depth range, the controller 80 will inflate the inflatable bladder 70 to hold back wastewater flow through the sewer line 24 upstream of the inlet channel 60. The inflated bladder 70 in effect acts like a dam by reducing the flow area through which wastewater may pass into the inlet channel 60, thereby increasing the head pressure and causing the depth of the wastewater in the sewer line 24 upstream of the bladder 70 to increase. The increase in the depth of the wastewater flow upstream of the bladder 70 results in an increase in head pressure on the wastewater flow entering the inlet channel 60, which will have the effect of increasing the flow velocity of the wastewater flow entering the inlet channel 60. The controller 80 will adjust the throat 62 of the inlet channel 60 as necessary in the manner discussed hereinbefore to ensure that the flow velocity does not exceed the design threshold velocity.

The sewer energy mill system 10 may be designed such that the paddlewheel drum 40 (or other energy extracting device), the alternator 30 and the drive mechanism 50 may be pre-assembled into a supporting manhole structure 20 to form a module that may be installed in place into a sewer system as a single unit. Further, the paddlewheel 40 (or other energy extracting device) and the alternator 30 may be mounted within a manhole structure such that the paddlewheel drum 40, the alternator 30 and the drive mechanism 50 may be inserted and extracted from the manhole structure 20 as a modular unit. For example, in the embodiment of the sewer energy mill 10 depicted in FIGS. 1 and 2, the respective ends of the shaft 32 of the alternator 40 and the respective ends of the shaft 42 of the paddlewheel drum 40 are supported in rails 28 extending generally vertically on diametrically opposite sides of the wall of the manhole structure 20. The respective ends of the shafts 32 and 42 are so engaged with the rails 28 as to permit the shaft ends to translate upwardly and downwardly within the rails 28.

In this manner, the paddlewheel drum 40, the alternator 30 and the drive mechanism 50 may be lowered into position and lifted out of the manhole structure 20 as a modular unit. Additionally, the paddlewheel 40, the alternator 30 and the drive mechanism 50 may be raised within the manhole structure 20 as a modular unit, thereby extracting the paddlewheel drum 40 from the channel 25 in the event that the wastewater flow through the sewer line 24 becomes so excessive as to risk damage to the energy extracting device. The paddlewheel 40, the alternator 30 and the drive mechanism 50 may be partially withdrawn, as a modular unit, upwardly a selective distance during a high flow condition that does not necessitate full withdraw to prevent damage to the system. This variable extraction permits the modular unit to be selectively raised such that a portion of the paddlewheel remains in the flow stream, thereby still providing drive power for rotating the alternator for electric power generation, albeit likely at a reduced power output. In an embodiment, at least one depth sensor 94L may be installed in the manhole chamber 22 at least one preselected distance above the crown of the sewer line to sense the raise of wastewater up the manhole chamber and transmit a signal to the controller 80 indicative of the raise of wastewater to the level of that preselected distance up the manhole shaft. The controller 80 may be programmed to initiate a full or a variable extraction of the modular unit in response to the receipt of a signal from the at least one depth sensor 94L or from multiple depth sensors positioned at different preselected distances up the manhole chamber 22.

Additionally, velocity, depth and pressure sensors, 92U, 94U, 96U may be located more remotely upstream of the bladder 70 for providing information regarding upstream wastewater flow conditions to the controller 80. Inclusion of such more remotely located upstream sensors would enable the controller 80 to monitor upstream flow conditions and take protective action in the event that a potentially excessive wastewater flow condition, such as a surcharge condition, is detected. In a surcharge condition, wastewater flow through the main sewer line 24 becomes so excessive that wastewater backs up into lateral sewer lines entering the main sewer line 24 upstream of the manhole structure 20. In the event that a potential surcharge condition is detected, the controller 80 can extract the paddlewheel drum 40 (or other energy extracting device) from the flow channel 25 thereby preventing damage thereto and also clearing the flow channel 25 so that the paddlewheel drum 40 does not obstruct wastewater flow during the existence of the surcharge condition.

One or more gated wastewater bypass lines, 124, may be included in connection with the sewer energy mill system 10 to provide for establishing a flow path through which some of the wastewater flow may be diverted rather than flowing through the channel 25 during excessive wastewater flow conditions, thereby obviating and at least delaying the need to extract the paddlewheel drum 40 from the flow channel 25. The bypass lines 124 tap into the sewer line 24 upstream of the inlet channel 60 to receive wastewater flow when opened to flow and reenter the sewer line 24 downstream of the flow channel 25, thereby bypassing the waterwheel drum 40. The gated bypass lines 124 may also be selectively opened when necessary to bypass a portion of the wastewater flow around the paddlewheel drum 40 to maintain operation of the sewer energy mill system 10 at optimal efficiency. In an embodiment, an additional modular sewer energy mill system 10 (not shown) may be selectively positioned with respect to the at least one wastewater bypass lines 124, or if desired each of the bypass lines 124, for converting the kinetic energy of wastewater flowing through the at least one wastewater bypass line 124 into electrical energy.

As noted previously, in other embodiments, the energy extracting device could comprise a water turbine having a plurality of paddles mounted to a rotatable shaft, such as for example, but not limited to, a Pelton wheel, or other device for extracting energy from the momentum of flowing water for rotating a shaft to which the device is mounted. In general, the efficiency of the energy extracting device in the sewer energy mill system 10 depends upon the wastewater head pressure and the wastewater velocity delivered to the energy extracting device. The selection of the particular energy device employed would depend upon expected wastewater flow conditions including available water pressure head, available wastewater mass flow rate, and available wastewater velocity. Also as noted previously, various drive mechanisms may be employed for transmitting rotation of the shaft of the energy extracting device into rotation of the shaft of the alternator.

The terminology used herein is for the purpose of description, not limitation. Specific structural and functional details disclosed herein are not to be interpreted as limiting, but merely as basis for teaching one skilled in the art to employ the present invention. Those skilled in the art will also recognize the equivalents that may be substituted for elements described with reference to the exemplary embodiments disclosed herein without departing from the scope of the present invention.

While the present invention has been particularly shown and described with reference to the exemplary embodiment as illustrated in the drawing, it will be recognized by those skilled in the art that various modifications, some of which may have been alluded to herein, may be made without departing from the spirit and scope of the invention. It is intended that the present disclosure not be limited to the particular embodiment(s) disclosed as, but that the disclosure will include all embodiments falling within the scope of the appended claims.

We claim:

1. A sewer energy mill system for converting the kinetic energy of wastewater flowing through a sewer line into electrical energy, comprising:
an energy extracting device mounted to a rotatable shaft and positioned whereby wastewater flowing through the sewer line rotates the shaft of the energy extracting device;
an alternator for generating electricity, the alternator having a rotatable shaft, the shaft of the alternator operatively connected to the shaft of the energy extracting device in a driving relationship for rotating the shaft of the alternator; and
an inlet channel configured to be installed within the sewer line upstream with respect to wastewater flow of the energy extracting device, the inlet channel having a throat defining a variable flow area.

2. The sewer energy mill system as recited in claim 1 further comprising an inflatable bladder disposed in the sewer line upstream with respect to wastewater flow of the energy extracting device.

3. The sewer energy mill system as recited in claim 1 further comprising a controller operative to selectively vary the variable flow area of the throat of the inlet channel.

4. The sewer energy mill system as recited in claim 3 further comprising at least one flow velocity sensor associated with the controller for sensing a flow velocity of the wastewater approaching the energy extracting device and transmitting a signal indicative of the sensed flow velocity to the controller.

5. The sewer energy mill system as recited in claim 4 wherein the controller selectively varies the flow area of the throat of the inlet channel in response to the sensed flow velocity.

6. The sewer energy mill system as recited in claim 5 wherein the controller compares the sensed flow velocity to a design threshold velocity, selectively decreases the flow area of the throat of the inlet channel if the sensed flow velocity is less than the design threshold velocity, and selectively increases the flow area of the throat of the inlet channel if the sensed flow velocity exceeds the design threshold velocity.

7. The sewer energy mill system as recited in claim 4 further comprising an inflatable bladder disposed in the sewer line upstream of the inlet channel.

8. The sewer energy mill system as recited in claim 7 further comprising at least one flow depth sensor associated with the controller for sensing a depth of the flow of the wastewater approaching the energy extracting device and transmitting a signal indicative of the sensed flow depth to the controller.

9. The sewer energy mill system as recited in claim 8 wherein the controller selectively adjusts inflation of the inflatable bladder in response to the sensed flow depth.

10. The sewer energy mill system as recited in claim 8 wherein the controller compares the sensed flow depth to a design depth range and selectively inflates or deflates the bladder if the sensed flow depth is outside a design depth range.

11. The sewer energy mill system as recited in claim 1 wherein the energy extracting device comprises a paddlewheel drum having a plurality of paddles and mounted to a rotatable shaft.

12. The sewer energy mill system as recited in claim 1 further comprising a drive mechanism for operatively connecting the shaft of the alternator to the shaft of the energy extracting device for rotating the shaft of the alternator.

13. The sewer energy mill system as recited in claim 12 wherein the drive mechanism includes a drive gear mounted to the shaft of the energy extracting device and a driven gear mounted to the shaft of the alternator and a rotation of the drive gear is transmitted to the driven gear by a belt or chain drive.

14. The sewer energy mill system as recited in claim 3 further comprising at least one pressure sensor associated with the controller for sensing a head pressure of the wastewater upstream of the energy extracting device and transmitting a signal indicative of the sensed wastewater head pressure at a location upstream of the energy extracting device.

15. A sewer energy mill system for converting the kinetic energy of wastewater flowing through a sewer line into electrical energy, comprising a modular unit including:
an energy extracting device mounted to a rotatable shaft and positionable whereby wastewater flowing through the sewer line rotates the shaft of the energy extracting device;
an alternator for generating electricity, the alternator having a rotatable shaft, the shaft of the alternator operatively connected to the shaft of the energy extracting device in a driving relationship for rotating the shaft of the alternator; and
a drive mechanism for operatively connecting the shaft of the alternator to the shaft of the energy extracting device for rotating the shaft of the alternator; said modular unit selectively insertable and retractable within a manhole structure opening to the sewer line.

16. The sewer energy mill system as recited in claim 15 wherein the modular unit may be selectively fully or partially retracted in response to a raising wastewater level.

17. The sewer energy mill system as recited in claim 15 further comprising at least one gated wastewater bypass line for diverting wastewater around the energy extracting device when the at least one wastewater bypass line is open, said at least one wastewater bypass line being opened in response to a surcharge condition.

18. The sewer energy mill system as recited in claim 15 further comprising a second modular sewer energy mill system selectively positionable with respect to the at least one wastewater bypass line for converting the kinetic energy of wastewater flowing through the at least one wastewater bypass line into electrical energy.

19. A method for converting kinetic energy of wastewater flowing through a sewer line into electrical energy comprising the steps of:
providing an energy extracting device mounted to a rotatable shaft in a manhole chamber opening to the sewer with the energy extracting energy operatively disposed whereby wastewater flowing through the sewer line rotates the shaft of the energy extracting device;
providing an alternator having a rotatable shaft in operative association with the energy extracting device whereby the shaft of the energy extracting device is connected in driving relationship with the shaft of the alternator for rotating the shaft of the alternator;
installing an inlet channel having a variable flow area throat within the sewer line upstream with respect to wastewater flow of the energy extracting device;
selectively varying the flow area of the variable flow area throat in response to at least one of a sensed wastewater head pressure at a location upstream of the energy extracting device and a wastewater flow velocity approaching the energy extracting device.

20. The method as recited in claim 19 further comprising the steps of:
providing an inflatable bladder disposed in the sewer line upstream with respect to wastewater flow of the energy extracting device; and
selectively adjusting the inflation of the inflatable bladder in response to a sensed flow depth of wastewater flow approaching the energy extracting device if the flow depth is outside a design depth range.
